(19) United States
(12) Patent Application Publication
(10) Pub. No.: US 2018/0005529 A1
(43) Pub. Date: Jan. 4, 2018

(54) VISION SYSTEM

(71) Applicant: ELIEZER EDELSTEIN, HAIFA (IL)

(72) Inventor: ELIEZER EDELSTEIN, HAIFA (IL)

(21) Appl. No.: 15/544,003

(22) PCT Filed: Jan. 27, 2016
(86) PCT No.: PCT/IL2016/050089

§ 371 Date: Jul. 16, 2017

Related U.S. Application Data
(60) Provisional application No. 62/108,571, filed on Jan. 28, 2015.

(51) Int. Cl. G08G 1/16; H04N 5/247; B60R 1/00

(52) U.S. Cl. CPC G08G 1/167; B60R 1/00; H04N 5/247; B60R 2300/105; B60R 2300/30; B60R 2300/804; B60R 2300/802

(57) ABSTRACT

A vision system for a motor vehicle and a method for providing information to a driver of a motor vehicle, where the system includes at least one video camera, including a lens, adapted and configured to be mounted on a side of the vehicle with the lens facing forward, the lens having an angle of view that provides a field of view for allowing capture, simultaneously, of images of a view alongside the vehicle and of at least part of the side of the vehicle from the rear towards the front of the vehicle, and a processor coupled to the at least one video camera, the processor adapted and configured to process the captured images and provide processed images for display on a monitor and/or vehicle orientation information to a computerized vehicle operation system.

### FIELD OF THE INVENTION

The present invention relates to mounting cameras on motor vehicles, to permit a driver to view areas that otherwise could not be seen.

### BACKGROUND OF THE INVENTION

While driving a motor vehicle, the driver has a good view of the area in front of the vehicle and the area in the back of the vehicle through the rear view mirrors. In addition, newer cars have rearview cameras to improve visibility while driving in reverse. However, the driver has no view of the sides of the vehicle and its position relative to the lane or to the street. The driver cannot see the location of both sides of his vehicle in relation to the edges of the lane he is driving in and does not know where actually his vehicle is located in the width of the lane. The driver can only estimate the position of the vehicle in respect of the edges of the lane, usually on the driver's side. Similarly, the driver has poor visibility of his vehicle relative to other vehicles driving in the same direction on a multi-lane road.

The side view mirrors of the vehicle provide the driver with a view of the sides of the vehicle to the back so as to view vehicles which are approaching from behind. However, the driver cannot see the sides of his vehicle and the edges of the lane, from the back towards the front, in order to ascertain the position of his vehicle in the width of the lane or relative to other vehicles. In a vehicle having a left side steering wheel, the driver has a reasonable estimation of the position of the left side of the vehicle relative to the left edge of the lane. However, his estimation of the position of the right side of the vehicle relative to the right side lane, or relative to the right side sidewalk or relative to vehicles parked along the right side of the road, is very poor. Thus, driving in a narrow street, with vehicles parked on the side, can be stressful for the driver, as he cannot see the width of his car relative to the distance from the parked vehicles on the side of the street.

Thus, it would be desirable to have a simple and inexpensive apparatus that would provide the driver with information of the actual width and position of his vehicle in the width of a lane or street.

### SUMMARY OF THE INVENTION

The present invention relates to mounting video cameras on motor vehicles to permit a driver to view areas that otherwise could not be seen. Specifically, the invention relates to installing video cameras on one or both sides of the vehicle, viewing forward, in order to view the side of the vehicle and areas on along the length of the vehicle, as well as adjacent vehicles or passing vehicles. The captured images are processed or analyzed and can be displayed, simultaneously or one at a time, on a monitor that can be viewed by the driver, or vehicle orientation information can be provided to a computerized vehicle operation system.

The present invention, according to one embodiment, includes a system of one or two video cameras, installed on one or both sides of the vehicle, one on each side. The cameras face forward, towards the front end of the vehicle, viewing and capturing images of the side of the vehicle and anything beside the vehicle for example, the edge of the lane, simultaneously. The images captured by the cameras are displayed on a monitor seen by the driver or processed by a computerized driving system. Using the system according to the present invention, the driver not only can assess the vehicle's position in the lane, he can see the vehicle's location on the road. The system can help the driver to drive safely in narrow streets and alert the driver when he passes too close to other vehicles. The cameras are mounted on the sides, viewing forward, preferably at a rear part of the vehicle.

There is provided, according to the present invention, a vision system for a motor vehicle, the system including at least one video camera, including a lens, adapted and configured to be mounted on a side of the vehicle with the lens facing forward, the lens having an angle of view that provides a field of view for allowing capture, simultaneously, of images of a view alongside the vehicle and of at least part of the side of the vehicle from the rear towards the front of the vehicle, and a processor coupled to the at least one video camera, the processor adapted and configured to process the captured images and provide processed images for display on a monitor and/or vehicle orientation information to a computerized vehicle operation system.

There is also provided, according to the invention, a method providing information to a driver of a motor vehicle, the method including providing at least one video camera including a lens having an angle of view that provides a field of view allowing capture, simultaneously, of images of a view alongside the vehicle and of at least part of the side of the vehicle, mounting the video camera on a side of the vehicle with the lens facing forward, capturing images, simultaneously, of a view alongside the vehicle and of at least a part of one side of the vehicle, from the rear towards the front, processing the captured images, and providing processed images for display to a monitor and/or vehicle orientation information to a computerized vehicle operation system.

### BRIEF DESCRIPTION OF THE DRAWINGS

The invention is herein described, by way of example only, with reference to the accompanying drawings.

FIG. 1A is a side view of a vehicle with a vision system including a camera installed on a side and at the rear part of the vehicle, according to some embodiments of the invention.

FIG. 1B is a front view of a vehicle with two cameras installed, one on each side, facing forward of the vehicle, according to some embodiments of the invention.

FIG. 1C is a back view of a vehicle with two cameras installed, one on each side facing forward of the vehicle, according to some embodiments of the invention.

FIG. 1D is a side view of a vehicle with a vision system including a camera installed near the center part of the vehicle, according to alternative embodiments of the invention.

FIG. 2 is an illustration of a monitor displaying simultaneously side by side images captured by two cameras installed on each side of the vehicle facing forward of the vehicle, according to some embodiments of the invention.

FIG. 3 is an illustration of a vehicle's built-in monitor with images from two side view cameras, according to embodiments of the invention.

FIG. 4 is a top view of a vehicle with a vision system according to some embodiments of the invention;

FIGS. 5A and 5B are schematic top view illustrations of the vision system, according to embodiments of the invention, in operation;

FIG. 6 is a top view illustration of an elongate vehicle with cameras installed on the sides of the vehicle facing forwards, according to alternative embodiments of the invention.

### DETAILED DESCRIPTION OF THE INVENTION

The present invention relates to mounting cameras on motor vehicles, to improve the driver's capabilities to see the road in a way that otherwise could not be seen. Specifically, the invention relates to installing at least one video camera on a side of the vehicle, facing forwards, to view the side of the vehicle as well as an area at the side of the vehicle. Each video camera includes a lens having an angle of view that provides a field of view allowing capture, simultaneously, of images of a view alongside the vehicle and at least of part of the side of the vehicle, from the rear towards the front. The cameras are mounted on a side of the vehicle with the lenses facing forward.

Preferably, the camera is mounted on a rear part of a vehicle. For purposes of the present invention, the “rear” of a vehicle extends from the side of the vehicle behind the driver's seat and all the way to the side of the rear bumper of the vehicle. The camera is mounted on the vehicle facing forwards, on one or on both sides of the vehicle, to permit the driver to see at least part of the side of the vehicle at the same time as areas beside the vehicle and in front of the camera (the view alongside the vehicle) that otherwise could not be seen. Since the driver can see the side of the vehicle and, at the same time, the road beside his vehicle, he or she can better evaluate the relative distance between the side of the vehicle and the curb, lane marker, adjacent cars, etc., to improve the safety of driving and avoid mishaps. Similarly, the cameras can improve the visibility of the driver's vehicle relative to other vehicles driving in the same direction on a multi-lane road. The camera can be mounted by means of a base or other mounting element.

If only one video camera is installed, it is most effective on the passenger's side of the vehicle, where the driver has less visibility. If two cameras are installed, one will be installed on each side of the vehicle.

The images captured by the video cameras can be analyzed in a processor that can be in the vehicle or at a remote location. If desired, the images can be recorded for future reference. From the images captured by the cameras, the driver can see, on the monitor, the sides of the car and the location of the vehicle in the lane. The system is particularly helpful driving in a narrow street, and/or driving on a street with vehicles parked on the side of the street. The system provides the driver with data of the actual orientation of the vehicle in the street, so he will not drive too close to adjacent vehicles or objects. With the help of the cameras, it becomes much safer to drive in foggy weather or to pass a truck on a highway. In addition, the system processor can analyze the road's image, calculate its curvature and alert the driver in the event that his unsafe orientation.

As stated above, vehicles are equipped today with a rearview camera and a monitor for reverse driving. The same monitor can be used to display the images captured by the cameras of the present invention, since the rearview camera and the cameras mounted on the sides of the vehicle, according to the present invention, do not operate at the same time. In cars without a built-in monitor, a separate monitor can be installed to display the side view images.

It is to be understood that the phraseology and terminology employed herein is for the purpose of description and should not be regarded as limiting. For the sake of clarity, non-essential elements were omitted from the drawings.

With specific reference now to the drawings in detail, it is emphasized that the particulars shown are by way of example only and for purposes of illustrative discussion of the preferred embodiments of the present invention in a non-limiting manner. In this regard, no attempt is made to show structural details of the invention in more detail than is necessary for a fundamental understanding of the invention. The description taken with the drawings will show those skilled in the art how the several forms of the invention may be embodied in practice.

The video camera system of the invention includes various components. The system includes one or two video cameras mounted on one or on both sides of the vehicle, viewing forward, preferably mounted on the rear part of the vehicle, according to exemplary embodiments of the invention. The camera or cameras are mounted in locations permitting capture of images of the side of the vehicle and of the view alongside the vehicle. Preferably, the images of the two cameras are displayed directly on a monitor for the driver to view the images in real time. The display area of the monitor can be split into two parts, each part displaying the image captured by one camera. The two images of the cameras can be combined into one frame by a video combiner (splitter) and displayed on a monitor as one. Alternatively, the system can be configured to display on the monitor images of each side camera separately. The monitor can be the vehicle's display panel or any other monitor installed permanently or temporarily in the vehicle. In addition, the images of the side view cameras can be processed and the results can be used to send the driver an alert signal, in the event of unsafe orientation, or another vehicle is attempting to merge into the same lane, or the results can be used for computerized driving.

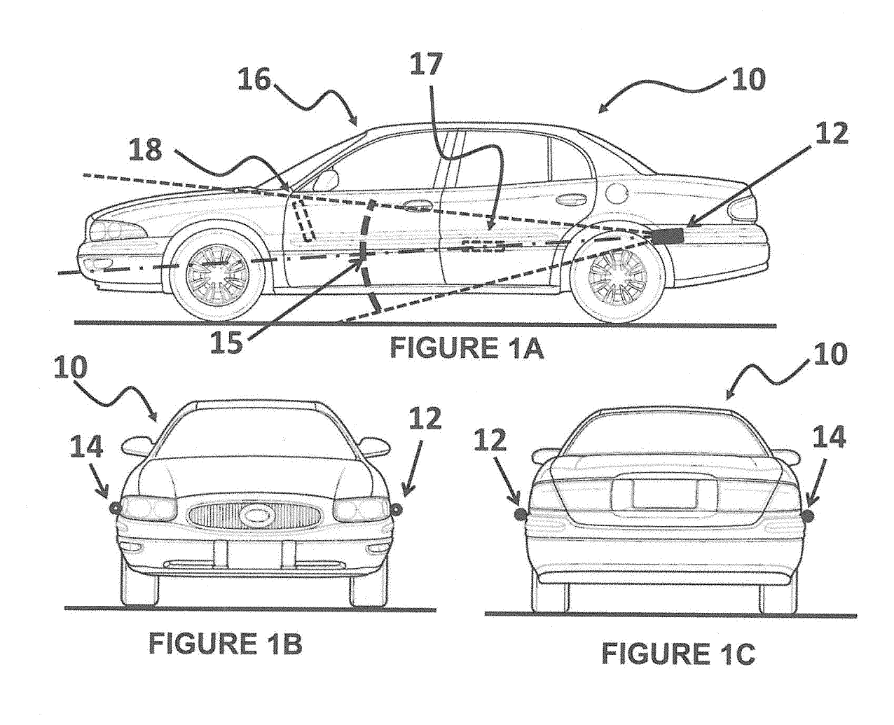

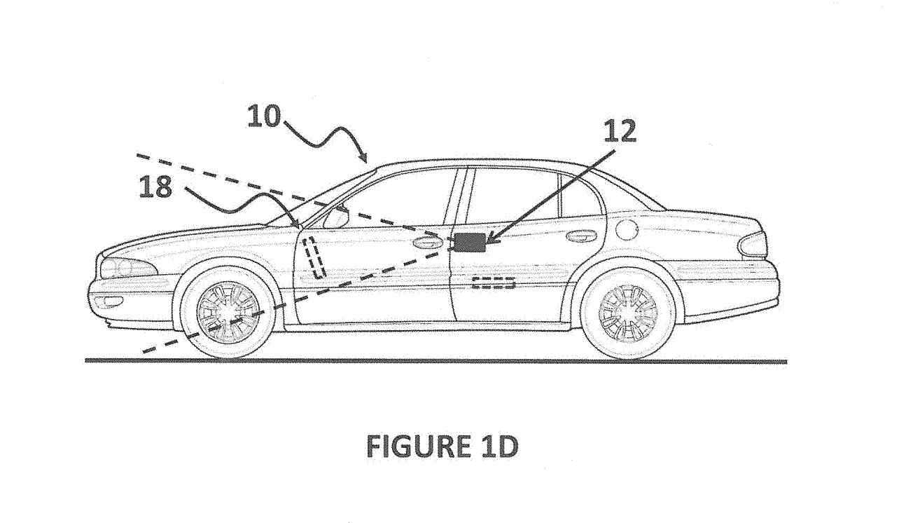

Referring, now, to FIGS. 1A to 1C, there are shown side, front and rear views, respectively, of a vehicle [10] illustrating the installation of a pair of video cameras [12, 14], each on one side of the vehicle at the rear part of the vehicle [16], according to some embodiments of the invention. In this illustrated embodiment, the camera has a lens and is disposed on the side of the rear wheel fender, with the lens facing forward. The lens has an angle of view that provides a field of view for allowing capture, simultaneously, of images of a view alongside the vehicle and of at least part of the side of the vehicle from the rear towards the front of the vehicle. A processor (not shown) is coupled to the video camera, the processor adapted and configured to process the captured images and provide processed images for display on a monitor and/or vehicle orientation information to a computerized vehicle operation system. In FIG. 1A, only the left side camera [12] can be seen. There is also indicated, in dashed lines, an exemplary field of view (FOV) [1 5] of the video camera.

The camera [14] on the right side of the vehicle can be seen in FIGS. 1B & 1C and is substantially the same as described with regard to camera [12]. The cameras are mounted on a rear part of the vehicle [16], with the lenses facing forward, in such a way as to provide images of the side of the vehicle together with a view alongside the vehicle, such as the edge of the lane at the side of the vehicle, and any vehicles or other objects that are near the sides of the vehicle. The images of one or of both cameras are displayed on a monitor [18], disposed inside the vehicle, in a position easily viewed by a driver while driving. If desired, an optional video combiner (splitter) [17] can be installed, to combine the images received from the two cameras into one video signal to be presented on a monitor that, by itself, does not have the capability to present two video signals. It will be appreciated that the splitter can be located at any location on or in the vehicle. It will further be appreciated that a splitter can be provided to combine images from various different cameras already on the vehicle, in addition to the cameras on the sides of the vehicle.

FIG. 1B is a front view of vehicle [16] with two cameras [12, 14] installed, one on each side at the rear part of the vehicle facing forward of the vehicle. As stated above, the cameras in this embodiment are disposed on the side of the vehicle's rear wheel fender, facing forward.

FIG. 1C is a view from the rear of vehicle [16] with the two cameras [12, 14] mounted on the vehicle, one on the right side and the other on the left side of the vehicle, respectively.

Referring, now, to FIG. 1 D, there is shown a schematic side view of a vehicle [10], according to some embodiments of the invention, illustrating the installation of a camera [12], as described above with reference to FIG. 1A, on one side of the vehicle, behind the driver's seat, facing forward. It will be appreciated that a second camera (not shown) can be provided on the other side of the vehicle, and that a processor and monitor, as described above, can be coupled to this camera.

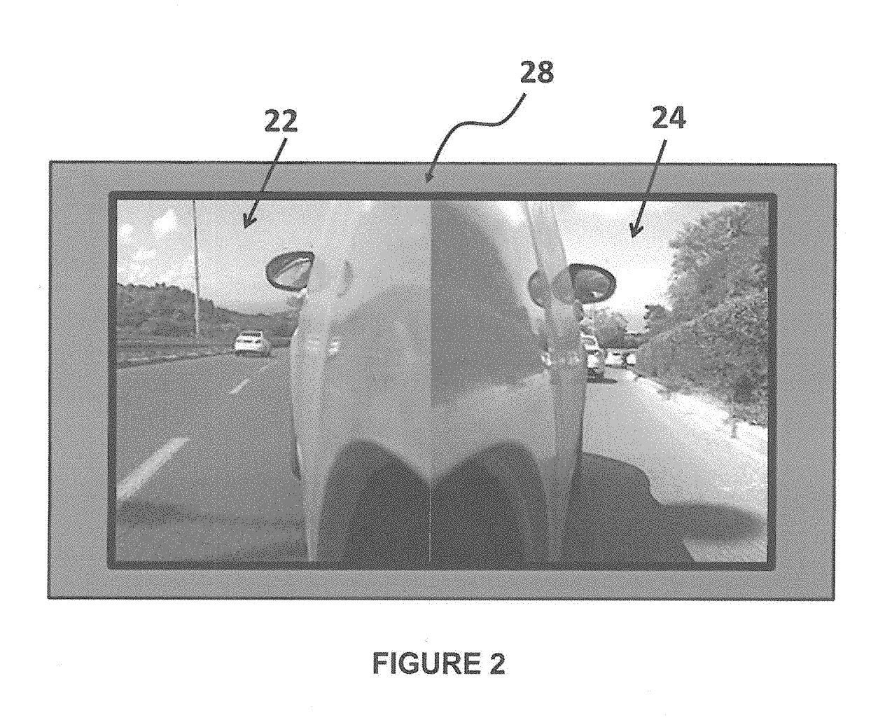

FIG. 2 is a sample screen shot of a monitor [28] displaying simultaneously side by side images captured by two cameras installed on each side of the vehicle. As can be seen in the illustrated shot, monitor [28] displays an image which is a combination of an image [22] captured by camera [12] and an image [24] captured by camera [14] (as shown, for example, in FIGS. 1A-1C). Preferably, as seen in the illustrated embodiment, each camera image includes both the side of the vehicle on which it is mounted on, as well as of a view alongside the vehicle, for example, the edge of the lane on the side of the vehicle, and any vehicles or other objects in the adjacent lane and along the shoulder.

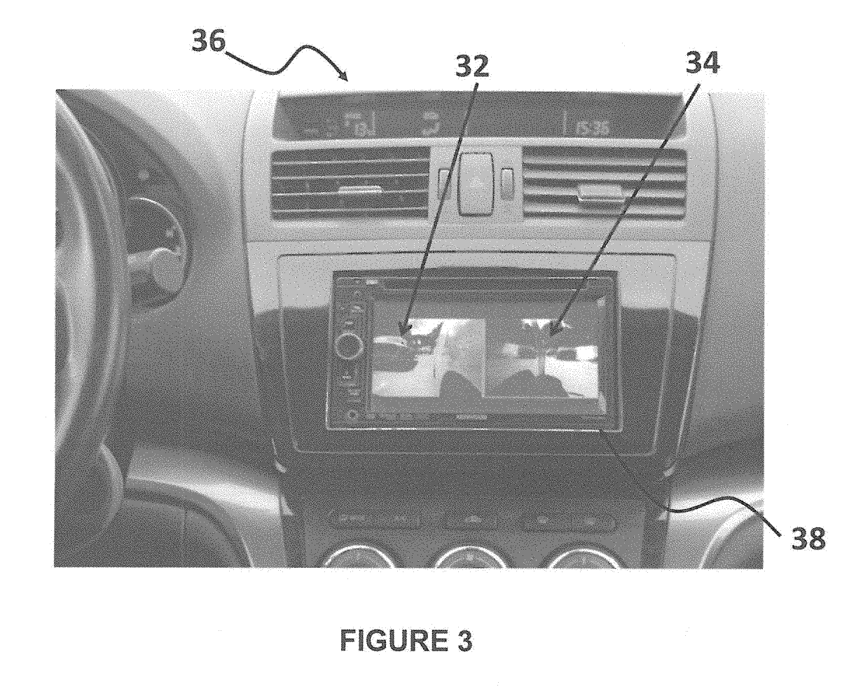

FIG. 3 illustrates a built-in monitor [38] displaying the images of the cameras, according to some embodiments of the invention. Monitor [38] shows two images [32, 34] from the two cameras [12, 14] shown in FIGS. 1A-1C.

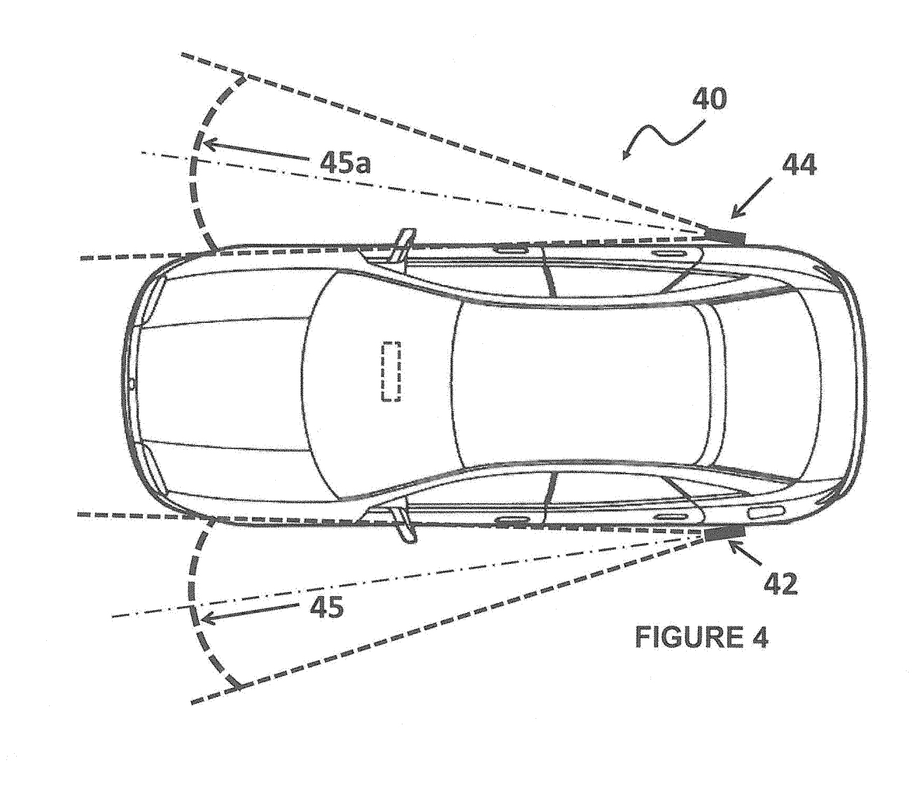

Referring, now, to FIG. 4, there is shown a schematic top view of a vehicle [40], according to some embodiments of the invention, illustrating the installation of a two video cameras [42] and [44] on both sides of the vehicle at the rear part of the vehicle facing forward. Each camera [42] and [44] has a lens and is disposed on the side of the rear wheel fender, with the lens facing forward. The lens has an angle of view that provides a field of view for allowing capture, simultaneously, of images of a view alongside the vehicle and of at least part of the side of the vehicle from the rear towards the front of the vehicle. A processor (not shown) is coupled to the video camera, the processor adapted and configured to process the captured images and provide processed images for display on a monitor and/or vehicle orientation information to a computerized vehicle operation system. In the illustrated embodiment, the FOV (fields of view) [45] and [45a] of the two cameras [42] and [44] are shown. It will be appreciated that the various cameras can have the same FOV or different FOV, as desired.

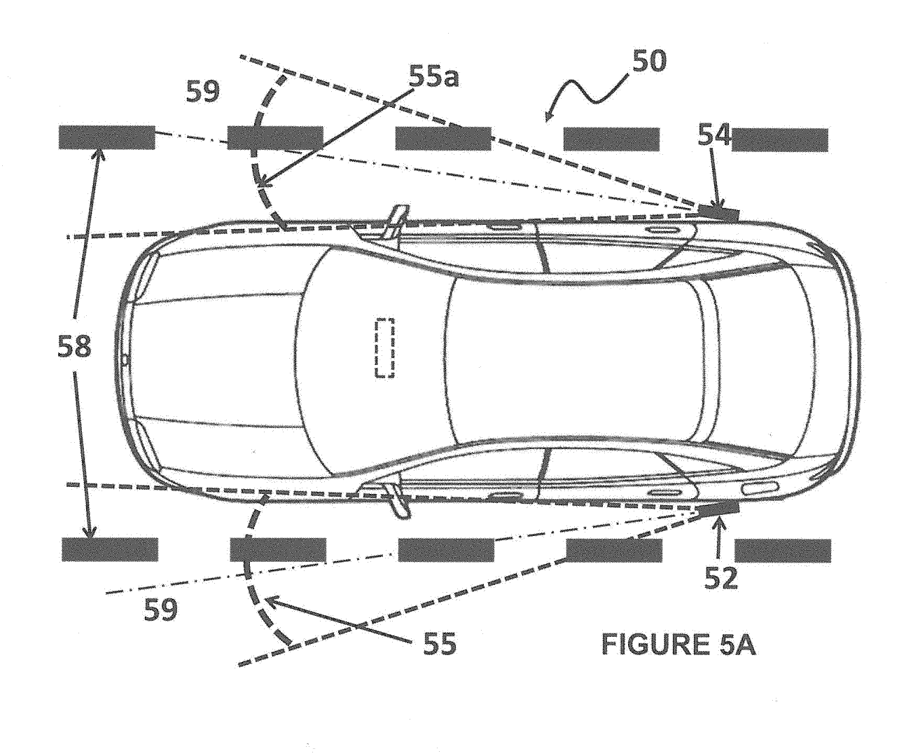

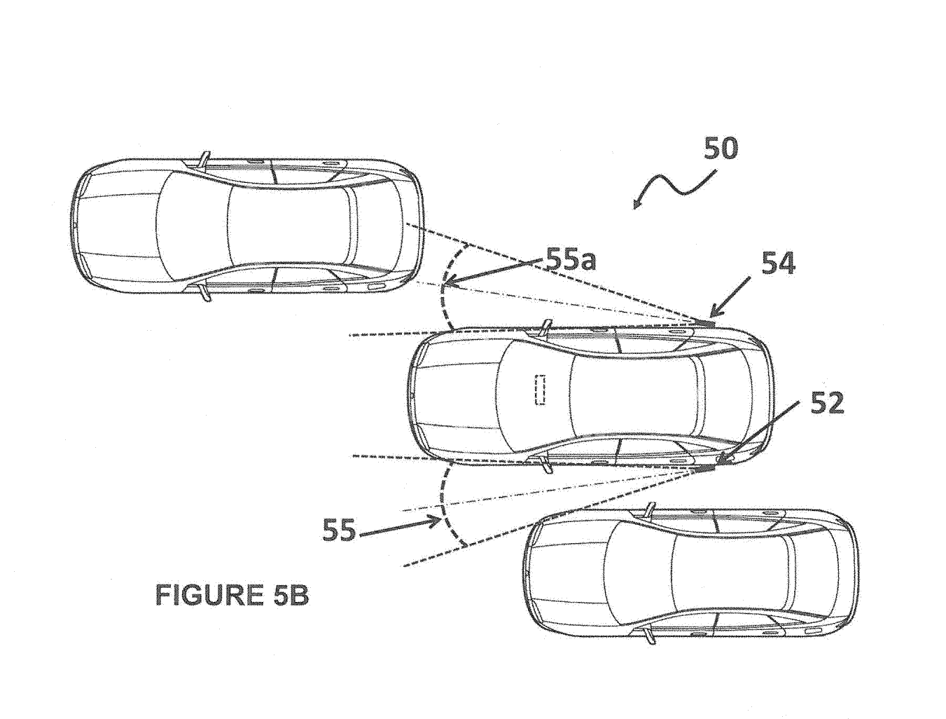

FIGS. 5A and 5B illustrate schematic top views of a vision system [50] of some embodiments of the invention in operation. Vision system [50] includes two video cameras [52] and [54], one mounted on each side of a vehicle [56], facing forward, to capture part of the side of the vehicle and of a view alongside the vehicle. Each camera [52] and [54], has a lens and is disposed on the side of the rear wheel fender, with the lens facing forward. The lens has an angle of view that provides a field of view for allowing capture, simultaneously, of images of a view alongside the vehicle and of at least part of the side of the vehicle from the rear towards the front of the vehicle. As can be seen, cameras [52] and [54] have horizontal FOV angles [55] and [55a], respectively. Accordingly, the view captured by the cameras includes the road markings [58] at the edges of the lane the vehicle is driving in, and portions of the lanes [59] on either side of the vehicle.

As can be seen in FIG. 5B, this arrangement permits the driver of vehicle [56] to see vehicles in adjacent lanes both in front and to the side of vehicle [56] and vehicles moving sideways from the rear towards the lane of vehicle [56]. A processor, as described above with reference to FIG. 4A, can be provided, if desired.

Thus, as can be seen, the method of providing information to a driver of a motor vehicle includes providing at least one video camera including a lens having an angle of view that provides a field of view allowing capture, simultaneously, of images of a view alongside the vehicle and of at least part of the side of the vehicle. The video camera or cameras are mounted on a side of the vehicle with the lens facing forward, to permit them to capture images, simultaneously, of a view alongside the vehicle and of at least a part of one side of the vehicle, from the rear towards the front. The captured images are processed and provided as processed images for display to a monitor and/or as vehicle orientation information to a computerized vehicle operation system.

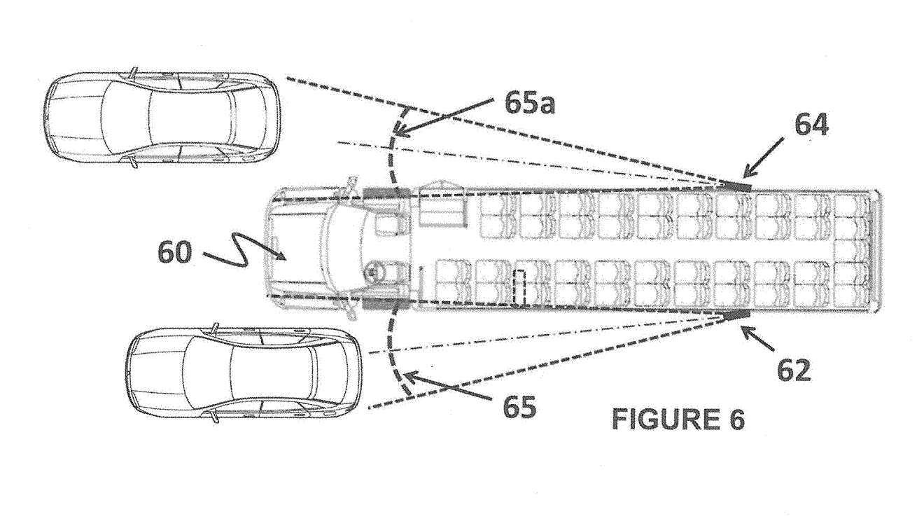

FIG. 6 is a top view of an elongate vehicle [60] with at least one camera, here shown as two cameras [62] and [64], installed on the sides of the vehicle, according to alternative embodiments of the invention. In this embodiment, the cameras are disposed close to the rear part of the vehicle. Each of these cameras is substantially as described above with regard to FIG. 5A. The cameras have horizontal FOV [65], [65a], respectively, which permit viewing of part of the side of the vehicle and of a view alongside the vehicle.

If desired, in any of the embodiments described herein, the video camera can be a camcorder, including recording capability for recording and saving the captured images.

It will be appreciated that the images can be transferred from the video cameras to the monitor or to the splitter, or from the splitter to the monitor, in any conventional manner, including, but not limited to, wired, wireless, Bluetooth, cellular, or in any other manner. In some embodiments, the splitter can be part of the monitor. The image processor of the monitor can be utilized to process the images from the cameras, or a separate image processor can be utilized.

It will further be appreciated that, in addition to or instead of viewing by a driver, the images captured by the cameras can be analyzed by a processor in the vehicle, or external to the vehicle, and supply information for computerized driving of the vehicle.

1. A vision system for a motor vehicle, the system comprising:
at least one video camera, including a lens, adapted and configured to be mounted on a side of the vehicle with the lens facing forward;
said lens having an angle of view that provides a field of view for allowing capture, simultaneously, of images of a view alongside the vehicle and of at least part of the side of the vehicle from the rear towards the front of the vehicle; and
a processor coupled to said at least one video camera, the processor adapted and configured to process said captured images and provide at least one of:
processed images including vehicle orientation data for display on a monitor; and
vehicle orientation information to a computerized vehicle operation system.

2. The system according to claim 1, further comprising a monitor adapted and configured for displaying said processed images.

3. The system according to claim 2, wherein said monitor is disposed on the vehicle in a location permitting said processed images to be viewed by the driver while driving.

4. The system according to claim 2, wherein said at least one video camera includes a first video camera and a second video camera, each adapted and configured to be mounted on one side of the vehicle, facing forwards, and wherein said monitor is adapted and configured for simultaneously displaying processed images captured by said first and second video cameras.

5. The system according to claim 4, further comprising a video combiner (splitter) for combining the images received from said first and second video cameras into a single video signal to be displayed on said monitor.

6. The system according to claim 1, wherein said at least one camera is disposed on a rear portion of the vehicle.

7. The system according to claim 1, wherein said view includes an edge of a lane in which the vehicle is traveling.

8. A method for providing information to a driver of a motor vehicle, the method comprising:
providing at least one video camera including a lens having an angle of view that provides a field of view allowing capture, simultaneously, of images of a view alongside the vehicle and of at least part of the side of the vehicle;
mounting the at least one video camera on a side of the vehicle with the lens facing forward;
capturing images, simultaneously, of a view alongside the vehicle and of at least a part of one side of the vehicle, from the rear towards the front;
processing said captured images; and
providing at least one of:
processed images including vehicle orientation data for display to a monitor; and
vehicle orientation information to a computerized vehicle operation system.

9. The method according to claim 8, further comprising:
transferring the processed images on a monitor disposed in the vehicle in view of a driver; and
displaying the processed images on the monitor so said images can be viewed by the driver while driving.

10. The method according to claim 8, further comprising splitting the processed images for simultaneous side by side display on a single monitor.

11. The method according to claim 8, wherein said step of mounting includes mounting said at least one camera on a rear portion of the vehicle.

12. The system according to claim 3, wherein said at least one video camera includes a first video camera and a second video camera, each adapted and configured to be mounted on one side of the vehicle, facing forwards, and wherein said monitor is adapted and configured for simultaneously displaying processed images captured by said first and second video cameras.

13. The system according to claim 6, wherein said view includes an edge of a lane in which the vehicle is traveling.
